(19) United States
(12) Patent Application Publication
(10) Pub. No.: US 2014/0113267 A1
(43) Pub. Date: Apr. 24, 2014

(54) Selecting Target Respondents For a Survey Based on Application Data of Mobile Devices

(71) Applicant: M4 STRATEGIES, Costa Mesa, CA (US)

(72) Inventors: Christopher David St. Hilaire, Long Beach, CA (US); Christopher Patrick Monahan, Irvine, CA (US); Jeffrey Joseph Harrelson, San Clemente, CA (US); Michael Scott Smith, Costa Mesa, CA (US)

(73) Assignee: M4 Strategies, Costa Mesa, CA (US)

(21) Appl. No.: 13/865,824

(22) Filed: Apr. 18, 2013

Related U.S. Application Data
(60) Provisional application No. 61/736,995, filed on Dec. 13, 2012.
(60) Provisional application No. 61/717,729, filed on Oct. 24, 2012.

(51) Int. Cl. G06Q 30/02

(52) U.S. Cl. CPC G06Q 30/0203
USPC 434/362

(57) ABSTRACT

The inventive subject matter provides apparatus, systems and methods for conducting a survey. The method includes the step of providing access to a server that stores information of potential respondents. The information of each potential respondent includes an identifier of a mobile device associated with the potential respondent. The method further includes a step of sending invitations to participate in the survey to a group of target respondents selected from the potential respondents based on retrieved application data from the mobile devices associated with the potential respondents. A system, including data storage and a processor, is also presented. The data storage stores information of potential respondents, including an identifier of a mobile device associated with the potential respondent. The processor retrieves data from the mobile devices and sends invitations to participate in the survey to mobile devices associated with a group of target respondents selected from the potential respondents.

This application claims the benefit of U.S. provisional application No. 61/736,995, filed Dec. 13, 2012, and U. S. provisional application No. 61/717729, filed Oct. 24, 2012. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The present invention relates to conducting surveys on mobile devices.

### BACKGROUND

The following description includes information that may be useful in understanding the present invention. It is not an admission that any of the information provided herein is prior art or relevant to the presently claimed invention, or that any publication specifically or implicitly referenced is prior art.

Public opinions have always been valuable assets for different organizations. For companies that are associated with manufacturing or selling goods and services, public opinions can be used to determine current and future trends of their corresponding markets. In addition, some organizations use opinions of their staffs to analyze efficiency of different departments and to determine areas for improvements. Furthermore, politicians track public opinions to drive their campaigns. As such, companies, employers, politicians and the like spend tremendous amounts of money and effort to capture opinions from different people.

Conducting a survey is an effective way to capture public opinions. First, the host (or creator) of a survey can generate specific questions to gather public opinions on a target area of interest (e.g., feelings toward a product, a political sentiment, etc.). Second, the survey host can also selectively choose only respondents who fall within a certain criteria (e.g., age, gender, ethnicity, political affiliation, etc.) to participate in the survey. Since public opinions are most Often time sensitive, it is important for a survey host to collect as many responses from the target respondents as quickly as possible.

It is known to use computer technologies to provide efficient manners for people to create surveys, distribute surveys, and generate and analyze feedbacks. For example, U.S. Pat. No. 8,086,648 to Weerman, titled “Computer Assisted Data Collection for Surveys and the Like”, filed Jun. 5, 2009, discloses a computerized tool for managing the work flow of a survey process, including questionnaire design, sample management, fieldwork monitoring, and final dataset production.

In addition, the Internet and mobile technologies have also made it much easier to generate and distribute surveys. For example, U.S. patent publication 2012/0095796 to Gately et al., titled “System and Method for Mobile Survey Management”, filed Apr. 29, 2011, discloses conducting surveys over mobile devices such as mobile phones and tablets. U.S. patent publication 2008/0119134 to Rao, titled “Mobile Device and Distribution Server for Surveys Using Interactive Media”, filed Oct. 29, 2007, discloses pushing survey questions to mobile devices (e.g., cell phones, PDA) and provides incentives for answering survey questions (e.g., free SMS).

This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

As mentioned, it is known to select target respondents to participate in a survey based on demographic criteria. Conventionally, a survey host/administrator can find a target group of respondent candidates that fall within a set of criteria under two different approaches. Under the first approach, the survey administrator includes questions related to the set of criteria in the survey, and sends requests to participate in the survey to all respondent candidates that are available. Based on answers to the questions related to the set of criteria, the survey administrator can filter out responses from respondents who do not fall within the set of criteria. However, this approach is inefficient as it requires the survey administrator to send out survey requests to many respondent candidates who are not part of the target group, and requires the survey administrator to review the answer in order to filter out those who are not part of the target group.

Under the second approach, the survey administrator collects information of its pool of available respondent candidates and stores the information in a data storage. When the survey administrator has selected a set of criteria for a new survey, the administrator finds respondent candidates that fall under the set of criteria by querying the data storage. This second approach is an improvement from the first approach as it has improved the efficiency in selecting target respondents. However, it still suffers a drawback because information about the respondent candidates is collected in advance. Since some of the information about a respondent candidate can be out-dated (e.g., age, current location, etc.), the information that is stored in the data storage might not reflect the most updated information of the respondent candidates. Thus, there is a need for an improved system for selecting target respondents to participate in a survey.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY OF THE INVENTION

The inventive subject matter provides apparatus, systems and methods for conducting a survey. In one aspect of the invention, a method of conducting a survey is presented. The method includes the step of providing access to a survey server that stores information of several potential respondents. The information of each potential respondent includes an identifier of a mobile device associated with the potential respondent.

The method also includes a step of retrieving application data from the mobile devices associated with the several respondents. In some embodiments, the application data from each mobile device comprises information that is gathered by an application of the mobile device. Examples of these data include a physical location of the mobile device (gathered from a location tracking module), history of the physical locations of the mobile device, a temperature of the environment in which the mobile device operates (gathered by a temperature sensor). In other embodiments, the application data of each mobile device includes information generated through the user's interaction with the mobile device, such as a browsing history of an Internet browser of the mobile device and a search history of an Internet browser of the mobile device.

The method includes the step of selecting a group of target respondents from the potential respondents as a function of the application data. The method further includes the step of configuring the mobile devices associated with the group of target respondents to present an invitation to participate in the survey.

In some embodiments, the group of target respondents can be selected based on whether the retrieved application data fall within a set of criteria. In other embodiments, the group of target respondents can be selected based on the physical (geographical) proximity of the mobile device to other mobile devices with attributes that fall within a set of criteria.

As the application data from the mobile devices can be changed in real-time, they are not stored on the survey server, and are retrieved from the mobile devices immediately before sending the invitations. In some embodiments, the application data are retrieved over a network (e.g., a cellular network).

In another aspect of the invention, a system for conducting a survey is presented. The system includes a data storage and a survey module. The data storage stores information of several potential respondents. The information of each potential respondent includes an identifier of a mobile device associated with the potential respondent.

The survey module is configured to retrieve application data from the mobile devices associated with the potential respondents. The processor is also configured to select a group of target respondents from the potential respondents as a function of the retrieved application data. The survey module is further configured to configure the mobile devices associated with the group of target respondents to present an invitation to participate in the survey.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic of a survey administration system 100 of some embodiments.

FIG. 2 is a schematic of a mobile device that can cooperate with the survey administration engine of FIG. 1 to facilitate and conduct a survey.

FIG. 3 illustrates an example of selecting target respondents based on application data.

FIG. 4 illustrates an approach to improving power consumption in the embodiments of FIG. 3.

### DETAILED DESCRIPTION

It should be noted that any language directed to a computer or computing device should be read to include any suitable combination of computing devices, including servers, interfaces, systems, databases, agents, peers, engines, modules, controllers, or other types of computing devices operating individually or collectively. One should appreciate the computing devices comprise one or more processing units (e.g., processors, processor cores, etc.) configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

The present inventive subject matter is drawn to systems, configurations, and methods of selecting a target group of respondent candidates out of a pool of available respondent candidates to participate in a survey based on information not resided or controlled by the survey administrator. In some embodiments, a survey is conducted through the mobile devices of the respondents. In these embodiments, a survey administration system is configured to select the target group of respondent candidates to participate in the survey based on attributes of the mobile devices (e.g., current location, temperature of the environment, etc.) associated with the respondent candidates.

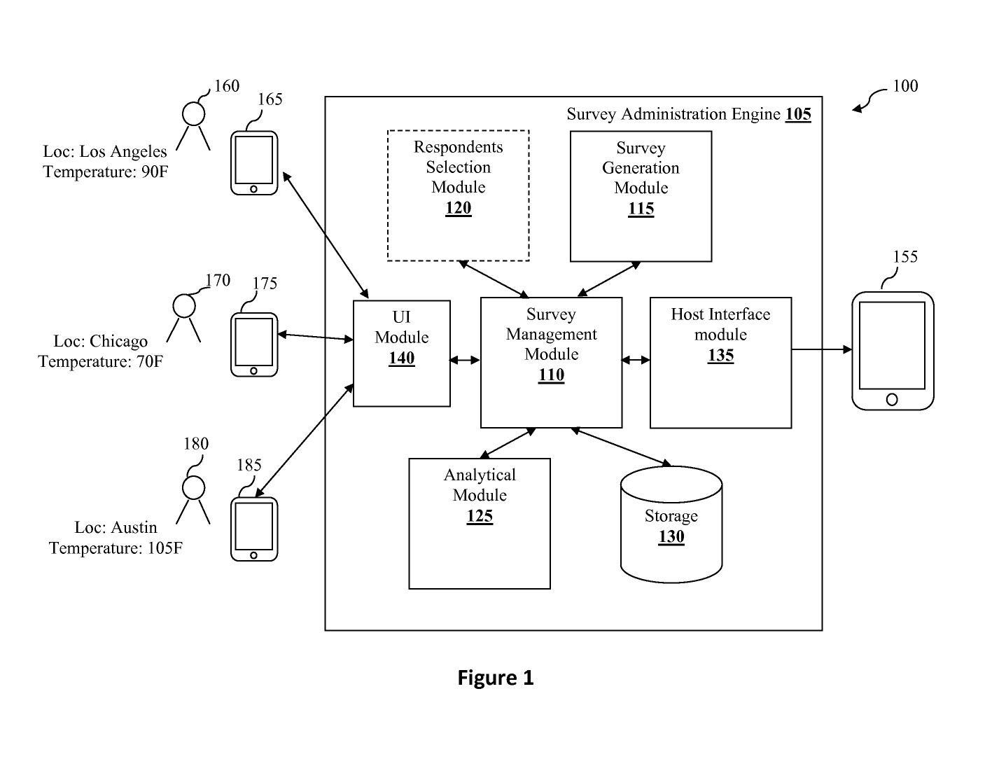

FIG. 1 illustrates an example survey administration system 100 of some embodiments. In FIG. 1, the survey administration system 100 includes a survey administration engine 105. The survey administration engine 105 can be one or more software programs that work in concert to facilitate the process of generating and conducting electronic surveys. In addition, the survey administration engine 105 can include many modules that can be located and executed in one or more computing devices, and the modules communicate with each other over a network (e.g., a local area network, the Internet, etc.). As shown, the survey administration engine 105 includes a survey management module 110, a survey generation module 115, a respondents selection module 120, an analytical module 125, a storage 130, a user interface (UI) module 140, and a host interface module 135 for interfacing with a survey administrator (survey host).

In some embodiments, the storage 130 is non-transitory permanent data storage such as a hard drive, a flash memory, etc. In some embodiments, the survey management module 110, the survey generation module 115, the respondents selection module 120, the analytical module 125, the user interface (UI) module 140, and the host interface module 135 are software modules that are executed by a set of processing units (e.g., processor, processing core, etc.) to perform the functions described herein.

A survey administrator (or a survey host) is usually a person (or an organization) that conducts a survey using the survey administration engine 105. The survey administration engine 105 of some embodiments can interact with the survey administrator via a computing device 155 that is communicatively coupled with the survey administration engine 105.

To interact with the survey administrator, the host interface module 135 of some embodiments generates a graphical user interface (GUI) that is presented through the display of the computing device 155. In some embodiments, the survey administration engine 105 allows the survey administrator to create a new survey and add survey questions for the new survey through the GUI. In some embodiments, the survey administration engine 105 allows the survey administrator to insert different types of questions. For example, the survey administrator can insert questions that limit answers to only yes/no or true/false, questions that limit answers to a specific range (e.g., 0% to 100%, etc.), questions that limit answers to one of a set of pre-defined answers (e.g., strongly disagree, disagree, neutral, agree, and strong agree, etc.), or questions that allow the respondent to freely provide answers.

In addition, the survey generation engine 105 of some embodiments can also allow the survey administrator to insert questions that prompt the user for non-text data such as images and videos from the mobile devices. The survey administrator can also insert questions that interact with the respondents. For example, some questions ask the respondent to define an area within an image (see U.S. provisional application 61/717,763 to S. Hilaire et al. entitled “Respondent-Defined Region of a Referenced Content”, filed Oct. 24, 2012), and some questions ask the respondent to rate different temporal portions of a video while being played on the mobile device or a live event occurred around the respondent (see U.S. provisional application 61/717,714 to St. Hilaire et al. entitled “Moment-to-Moment Feedback of Third Party Materials”, filed Oct. 24, 2012).

Upon receiving input from the survey administrator to create a new survey and to add survey questions to the new surveys, the survey generation module 115 instantiates a new survey object that includes all the added survey questions (and materials referenced by the survey questions). The survey management module 110 can (automatically or upon an initiation event by the survey administrator) send requests to participate requests to participate in the survey to different mobile devices (e.g., mobile devices 165, 175, and 185), so that respondents (e.g., respondents 160, 170, and 180) can take the survey via their mobile devices.

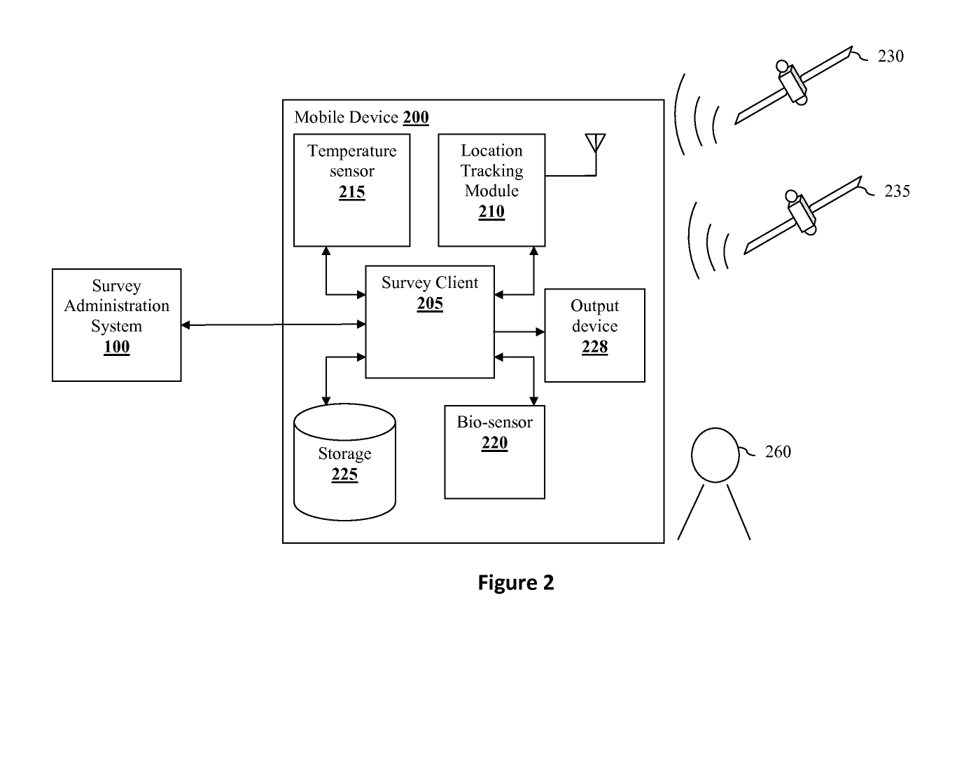

FIG. 2 illustrates a schematic of an example mobile device that can cooperate with the survey administration engine 105 to facilitate and conduct a survey. In this figure, mobile device 200 includes a survey client 205, a data storage 225, an output device 228, and different applications that have been installed on the mobile device 200. In this example, the applications installed on the mobile device 200 include a location tracking module 210, a temperature sensor 215, and a bio-sensor 220. In some embodiments, the survey client is a software module that has been installed on the mobile device 200, and is configured to communicative with the survey administration engine 105 via a network (e.g., a cellular network, the Internet, etc.). When the survey management module 110 sends an invitation to participate in the survey to the survey client 205 via the UI module 140, the survey client 205 is configured to present a notification (e.g., a notification icon on the screen of the mobile device, a blinking light of the mobile device, etc.) to the respondent 260. The survey client 205 can also receive from the survey management module 110 data related to the survey, such as questions and materials referenced by the questions (e.g., image data, video data, website links, etc.). When and if the respondent indicates that he/she would like to participate in the survey, the survey client 205 will present the questions (and any other referenced materials) to the respondent 260 via the display of the mobile device 200, collect answers, and send the answers back to the survey management module 110 via the network.

The location tracking module 210 is configured to use location tracking technologies (e.g., Global Positioning System (GPS), Radio Frequency Identification (RFID), Wireless Local Area Network (WLAN), etc.) to determine a precise location of the mobile device 200. As shown, the location tracking module 210 includes a wireless receiver for receiving signals from one or more transmitters 230 and 235 (e.g., satellites, radio frequency transmitter, Bluetooth® signal transmitter, etc.). Preferably, the wireless receiver receives signals from three or more transmitters for accurate and precise location determination. Once activated, the location tracking module 210 is configured to receive signals from the one or more transmitters. The location tracking module 210 then uses the signals received from the transmitters and information about the fixed location of the transmitters to determine a precise location of the mobile device 200. The survey client 205 can configure the location tracking module to perform the location tracking operation on demand, or periodically (e.g., every hour, every five minutes, etc.). Once it has received the location information, the survey client 205 can send the information to the survey administration system 100 or store the information in the data storage 225.

The temperature sensor 215 acts as a thermometer and collects temperature information of the environment in which the mobile device is operating. The bio-sensor 220 monitors and collects data related to the physical condition of the user of mobile device 200. Data collected can include body temperature, glucose level, heart rate, hydration level, and other biological measurable data. Once received the information from the temperature sensor 215 and/or the bio-sensor 220, the survey client 205 can send the information to the survey administration system 100 or store the information in the data storage 225.

It is also contemplated that mobile device 200 includes other user applications such as Internet browser (now shown). In some embodiments, the survey client 205 can also communicate with these applications to collect data (e.g., history of the user's interactions with the applications, such as browse history, search history, etc.) and store the data in the storage 225.

In some embodiments, the survey administration engine 105 allows a survey administrator to target a selected group of respondents for a survey, such that only respondents that fall under a certain criteria are requested to participate in the survey. For example, the survey administrator can specify, via the GUI, different criteria for selecting the target group of respondents for the survey. The respondents selection module 120 can selects a group of target respondents that satisfies the criteria and sent the invitations to participate in the survey to only the mobile devices associated with the group of target respondents. Examples criteria include respondents' attributes (e.g., age, gender, political affiliation, employment status, ethnicity, personal interests, current physical condition, income level, etc.) and environmental attributes (e.g., current location, temperature of the environment in which the respondent is located, etc.), however, additional criteria can be included by the survey administration system 100 for selecting the target group of respondents.

In some embodiments, the survey administration engine 105 stores information of potential respondent candidates in storage 130. The information of each potential respondent candidate can include name and an identification of a mobile device. In some embodiments, the survey administration engine 105 uses the identification of the mobile devices of potential respondent candidates to send/push survey data to these mobile devices in order to conduct the survey through the mobile devices. The survey administration engine 105 of some embodiments also stores attributes of each respondent candidate such as gender, age, residential location, education level, ethnicity, employment status, political affiliation, experience of the respondents, etc. in the storage 130. In these embodiments, the respondents selection module 120 can use these stored attributes to allow the survey administrator to select the target group of potential respondents. These attributes of the respondent candidates are usually collected well in advance before the survey administrator creates the survey. The attributes can be collected when someone signs up to become a respondent candidate with the survey administration system 100. The survey administration 100 can also send requests to the candidates periodically for updated information.

It is noted that the attributes of the respondent candidates that are stored in the storage 130 are limited to attributes that are fixed or at least do not change often. However, some of the attributes that the survey administrator would want to use as part of the set of criteria for selecting the target group of potential respondents can be dynamic in nature. Attributes such as “current location”, “historic locations”, “Internet browse history of mobile device”, “Internet search history of mobile device”, “heart rate,” and “temperature of the environment” can be extremely volatile, changing by days or hours. For example, a respondent can be in different geographical locations (even different cities) within a matter of hours. With this dynamic nature, it is unfeasible for the survey administration system 100 to store information in advance (i.e., before conducting the survey) and use the stored information to select respondents, as the stored information is likely outdated by the time it is used for the selection process.

Thus, for criteria with dynamic nature, the survey administration engine 105 of some embodiments is configured to select the target group of potential respondents based on the criteria as the attributes are being retrieved from the mobile devices.

Referring back to FIG. 1, mobile device 165 is located in Los Angeles with a temperature reading of the environment as 90 degrees Fahrenheit. Mobile device 175 is located in Chicago with temperature reading of the environment as 70 degrees Fahrenheit. Mobile device 185 is located Austin and its temperature reading of the environment is 105 degrees Fahrenheit.

In one example, the survey administrator can target a survey to respondents who are (1) located in Los Angeles or Chicago and (2) located in an area in which temperature is above 80 degrees Fahrenheit. When the survey administration engine 105 is signaled (e.g., by the survey administrator) to begin conducting the survey, the respondents selection module 120 retrieves the application data, in this case, current location information and temperature information, from the mobile devices 165, 175, and 185.

In this example, the respondents selection module 120 determines that only mobile device 165 satisfies the set of criteria and selects mobile device 140 to be part of the target group of respondent candidates. The respondents selection module 120 then configures the mobile device 165 to present an invitation to participate in the survey to its user 160.

Different embodiments use different techniques in this selection process. In some embodiments, the survey management module 110 sends a request to the survey client that is installed on each mobile device to retrieve the application data (e.g., location data, temperature data, Internet browsing history, etc.) from different applications on the mobile device. The survey management module 110 sends the application data to the respondents selection module 120 to select a group of target respondents that satisfy the criteria provided by the survey administrator. The respondents selection module 120 then reports the selected group of target respondents to the survey management module 110. After that, the survey management module 110 sends requests to participate in the survey to only the mobile devices associated with the selected group of target respondents.

In other embodiments, the respondents selection module 120 is part of the survey client. In these embodiments, the survey management module 110 sends the invitation along with the criteria to all mobile devices. The survey client of each mobile device then retrieves application data from different applications on the mobile device and determines whether the criteria are satisfied by checking the application data against the criteria. If the criteria are satisfied, the survey client will present a notification via the output device 220 of the mobile device (e.g., present a notification on the display of the mobile device, etc.) to invite the respondent who is associated with the mobile device to participate in the survey.

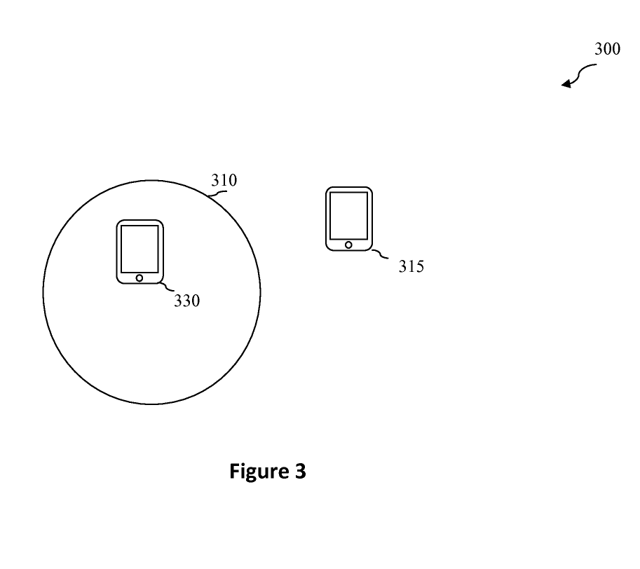

FIG. 3 illustrates an example in which the respondents selection module 120 determines a group of target respondents to participate in a survey based on location data retrieved from mobile devices associated with potential respondents. The administrator of a survey can define a target geographic region 310, for example, by inputting location parameters via the UI module 140, for determining the group of target respondents such that only respondents who are located within the target geographic region 310 will receive survey invitations. Even though the target geographic region 310 appears as a circle in FIG. 3, the region 310 can be any size, shape or specificity. It could, for example, be the boundaries of a state, a city, a park, a business location or a residential property. Alternatively, the target geographic region 310 could be a very specific, fixed location such as a specific retail store within a mall or a specific aisle in a grocery store. The target geographic region 310 can be specified using a variety of parameters such as longitude and latitude, political boundaries, property lines, proximity to other mobile devices, proximity to a sensor, proximity to a person, etc.

In FIG. 3, two mobile devices 315 and 330 belonging to two potential respondents are shown. As shown, mobile device 315 is outside the defined target region 310, while mobile device 330 is within the target region 310. When the survey administrator indicates to the survey administration system 100 to begin conducting the survey, the respondents selection module 120 retrieves application data (in this case, location information from the location tracking module of the mobile devices) from the mobile devices. Based on the retrieved location information, the respondents selection module 120 determines that mobile device 330 is located within the target region 310 while mobile device 315 is located outside of the target region. Therefore, the respondents selection module 120 configures only mobile device 330 to present a survey invitation to its user.

The survey administrator may also wish to keep the survey available to potential respondents for a period of time, such as a year, a month, a week or several hours. In such a case, respondent selection module 120 is configured to retrieve application data from the mobile devices on a periodic basis. When the respondents selection module 120 determines that mobile device 315 has relocated to within the target region 310 based on the retrieved location data from mobile device 315, the respondents selection module 120 would configure mobile device 315 to present a survey invitation to its user.

In order for application data to be retrieved on a periodic basis, different sensors or location tracking modules must be activated and application data (e.g., location data, sensor data, etc.) transmitted back and forth between the mobile device, the survey management module 110 and the transmitters 230, 235 (satellites, radio frequency transmitters, etc.) frequently. This can place significant burden on the mobile device's power source and network bandwidth.

To address these power and bandwidth consumption issues, some embodiments of the current invention may employ a system of using multiple criteria that can be used to adjust the periodicity or frequency within which the mobile device's applications are activated to collect application data (e.g., location tracking module 210 receiving signals from transmitter and calculating location, temperature sensor collecting temperature data, bio-sensor collecting user's physical condition data).

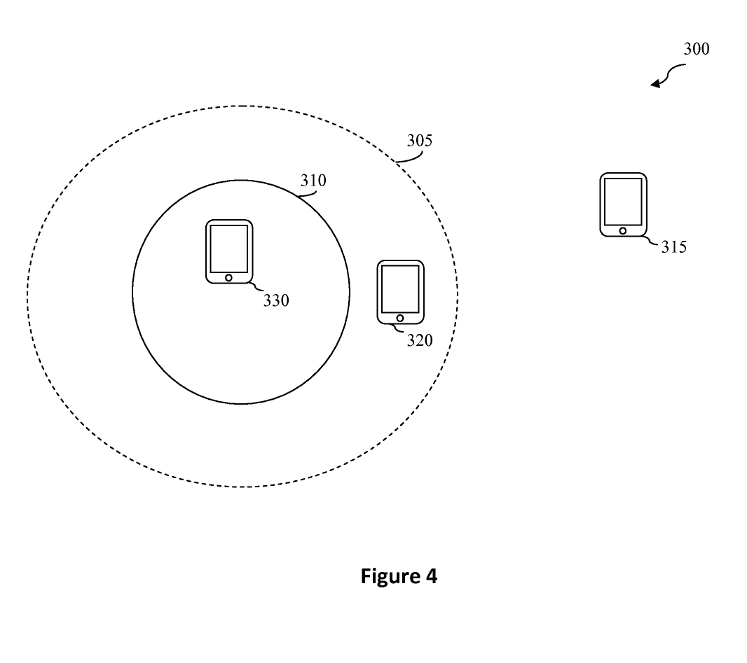

FIG. 4 illustrates an example of such a system when the survey administrator specifies criteria related to geographical location of the respondents. In FIG. 4, the survey administrator specifies criteria for selecting target respondents to participate in the survey that are identical to the criteria illustrated in FIG. 3. Specifically, the survey administrator targets the survey to respondents who are located within the target region 310. In this case, in addition to the target region 310, the survey administrator (or the respondent selection module 120) can also define a proximal region 305 that is larger than and encompassing the target region 310. When the respondents selection module 120 determines that the mobile device is outside of the proximal region 305, the respondents selection module can be configured to retrieve application data from the application(s) at a first interval (e.g., every hour, every day, etc.). However, when the respondents selection module 120 determines that the mobile device is within the proximal region 305 (but outside the target region), it can be configured to retrieve application data from the application(s) at a second interval shorter than the first interval (e.g., every 5 minutes, every 30 seconds, etc.).

For example, the respondents selection module 120 can be configured to retrieve location data from the location tracking module of the mobile device 315 every hour since it is outside the bounds of proximal region 305. However, the respondents selection module 120 can be configured to retrieve location data from the location tracking module of the mobile device 320 at a shorter frequency (e.g., once every minute), since it is within the proximal region 305. If a mobile device is in the target region 310, as in mobile device 330, the respondents selection module 120 could once again have a different interval of retrieving application data from the mobile device, or the respondents selection module 120 can be configured to pause or stop retrieving application data altogether.

In some embodiments, the respondents selection module 120 is configured to adjust the interval in which the respondents selection module 120 retrieves application data when the respondents selection module 120 determines that the mobile device has moved from one region to another region. In this example illustrated in FIG. 4, if the respondents selection module 120 determines that mobile device 315 has moved from outside the proximal region 305 to within the proximal region 305, the respondents selection module 120 can be configured to shorten the interval (i.e., increasing the frequency) in which the respondents selection module 120 retrieves application data from mobile device 315. Similarly, if the respondents selection module 120 determines that mobile device 320 has moved from within the proximal region 305 to outside the proximal region 305, the respondents selection module 120 can be configured to lengthen the interval (i.e., decreasing the frequency) in which the respondents selection module 120 retrieves application data from mobile device 320.

Although the above example illustrates an example of selecting target respondents using the survey administration system 100 when the survey administrator specifies criteria related to the geographical locations of the mobile devices, the operation of the survey administration system 100 is similar to those described above when the survey administrator specifies criteria related to other application data. For example, if the survey administrator defines a target temperature (or target range of temperature) as the criteria for selecting target respondents, the survey administrator (or the respondents selection module 120) can automatically define a broader range of temperature (proximal range) that encompasses the target range of temperature, and adjusts the intervals (or frequencies) of application data retrieval based on whether the retrieved temperature data is outside or within the proximal range of temperature and whether the retrieved temperature data is outside of within the target range of temperature.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A method of conducting a survey:
providing access to a survey server storing an identifier of a mobile device carried by a potential respondent;
sending, from the survey server to the mobile device, survey data associated with the survey;
then retrieving, by a survey client executed in the mobile device, information regarding proximity of the mobile device to an object within an enterprise; and
inviting, by the survey client, the potential respondent to participate in the survey as a function of the information.

2. The method of claim 1, wherein the mobile device utilizes one of the following tracking technologies to derive the information regarding proximity: RFID technology, WLAN technology, and Bluetooth technology.

3. The method of claim 1, further comprising receiving local environmental information from the mobile device, and using the local environmental information to assist in determining whether to invite the potential respondent to participate in the survey.

4. The method of claim 1, further comprising receiving from the mobile device browser history information, and using the browser history information to assist in determining whether to invite the potential respondent to participate in the survey.

5. The method of claim 1, further comprising receiving from the mobile device search history information, and using the search history information to assist in determining whether to invite the potential respondent to participate in the survey.

6. The method of claim 1, wherein the mobile device utilizes multiple tracking technologies to derive the information regarding proximity.

7. The method of claim 6, wherein the object is an aisle in a store.

8. The method of claim 6, wherein the object is another mobile device.

9. The method of claim 1, further comprising using biographic information to assist in determining whether to invite the potential respondent to participate in the survey.

10. The method of claim 1, further comprising providing an incentive to the potential respondent for participating in the survey.

11. A system for conducting a survey:
a data storage storing an identifier of a mobile device carried by a potential respondent;
a survey server configured to send survey data associated with the survey to the mobile device, regardless of a location of the mobile device; and
a survey client executed in the mobile device and configured to:
retrieve, from the mobile device, information regarding proximity of the mobile device to an object within a business, and
invite the potential respondent to participate in the survey as a function of the information.

12. The system of claim 11, wherein the mobile device utilizes one of the following tracking technologies to derive the information regarding proximity: RFID technology, WLAN technology, and Bluetooth technology.

13. The system of claim 11, wherein the survey module is further configured to receive local environmental information from the mobile device, and to use the local environmental information to assist in determining whether to invite the potential respondent to participate in the survey.

14. The system of claim 11, wherein the survey module is further configured to receive, from the mobile device, browser history information, and to use the browser history information to assist in determining whether to invite the potential respondent to participate in the survey.

15. The system of claim 11, wherein the survey module is further configured to receive, from the mobile device, search history information, and to use the search history information to assist in determining whether to invite the potential respondent to participate in the survey.

16. The system of claim 11, wherein the mobile device utilizes multiple tracking technologies to derive the information regarding proximity.

17. The system of claim 16, wherein the object is an aisle in a store.

18. The system of claim 16, wherein the object is another mobile device.

19. The system of claim 11, wherein the survey client is further configured to use biographic information to assist in determining whether to invite the potential respondent to participate in the survey.

20. The system of claim 11, wherein the survey client is further configured to provide an incentive to the potential respondent for participating in the survey.

21. The system of claim 11, wherein the survey client is further configured to use a first tracking methodology to derive the information regarding proximity when it is determined that the potential respondent is farther away from the object, and to use a second tracking methodology that is different from the first tracking technology to derive the information regarding proximity when it is determined that the potential respondent is closer the object.

22. The system of claim 11, wherein the survey module is further configured to retrieve from the mobile device the information regarding proximity periodically.

23. The system of claim 22, wherein the survey module is further configured to periodically retrieve the information regarding proximity at a lower frequency when it is determined that the potential respondent is farther away from the object, and to periodically retrieve the information regarding proximity at a higher frequency when it is determined that the potential respondent is closer to the object.

24. The method of claim 1, wherein retrieving the information regarding 1 proximity comprises using a first tracking methodology to derive the information regarding proximity when it is determined that the potential respondent is farther away from the object, and using a second tracking methodology that is different from the first tracking technology to derive the information regarding proximity when it is determined that the potential respondent is closer the object.

25. The method of claim 1, wherein retrieving the information regarding proximity comprises retrieving from the mobile device the information regarding proximity periodically.

26. The system of claim 25, wherein retrieving the information regarding proximity further comprises periodically retrieving the information regarding proximity from the mobile device at a lower frequency when it is determined that the potential respondent is farther away from the object, and to periodically retrieve the information regarding proximity from the mobile device at a higher frequency when it is determined that the potential respondent is closer to the object.
